(19) United States
(12) Patent Application Publication
(10) Pub. No.: US 2007/0154367 A1
(43) Pub. Date: Jul. 5, 2007

(54) Multi-layer ceramic substrate reforming apparatus and manufacturing method therefor

(75) Inventors: Jae Hyuk Jang, Sungnam (KR); Woo Jae Kim, Seoul (KR); Jeong Hoon Oh, Suwon (KR); Chan Hwa Chung, Goonpo (KR); Young Soo Oh, Sungnam (KR); Jae Hyoung Gil, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/525,031

(22) Filed: Sep. 22, 2006

(30) Foreign Application Priority Data
Dec. 29, 2005 (KR) 10-2005-0133033

(51) Int. Cl. B01J 10/00; A62D 3/00

(52) U.S. Cl. 422/189; 422/199; 422/240

(57) ABSTRACT

The invention relates to a reforming apparatus made of LTCC and a manufacturing method therefor. The reforming apparatus includes an upper cover made of ceramic material, having a fuel inlet at one side thereof, and an evaporator made of ceramic layers formed integrally with the upper cover, having a flow path to gasify fuel introduced through the upper cover. In the reforming apparatus, a reformer made of ceramic layers is formed at one side of the evaporator, having a catalyst in a flow path thereof to reform fuel gas entering from the evaporator into hydrogen. A CO remover made of ceramic layers is formed integrally with the reformer, having a catalyst to remove CO from reformed gas entering from the reformer. A lower cover is formed integrally at one side of the CO remover, having a reformed gas outlet to emit the reformed gas to the outside.

### CLAIM OF PRIORITY

This application claims the benefit of Korean Patent Application No. 2005-133033 filed on Dec. 29, 2005, in the Korean Intellectual Property Office, the disclosure of which is incorporated herein by reference.

### BACKGROUND OF THE INVENTION

1. Field of the Invention

The present invention relates to a thin reforming apparatus used for a fuel cell system, and more particularly, to a multi-layer ceramic substrate reforming apparatus for a micro fuel cell system, in which sheets of Low-Temperature Co-fired Ceramic (LTCC) material are stacked and fired into an ultra-light ceramic structure without requiring a gasket or screw, thereby effectively sealing reactive gas and minimizing the effect from reforming reaction temperature, and a manufacturing method therefor.

2. Description of the Related Art

In general, there have been increased uses of portable small-sized electronic devices including mobile phones, PDAs, digital cameras, notebook computers and the like. In particular, with Digital Multimedia Broadcasting (DMB) for mobile phones launching its service, small-sized mobile terminals are required to have improved power capabilities. A currently used lithium ion secondary battery has a capacity for 2-hour viewing of the DMB. In spite of ongoing efforts to increase the capacity of the battery, there have been growing expectations on micro fuel cells for a more fundamental solution.

The micro fuel cells are realized by a direct methanol method in which methanol is directly supplied to a fuel electrode, or by a Reformed Hydrogen Fuel Cell (RHFC) method in which hydrogen is extracted from methanol to supply the hydrogen to a fuel electrode. Since the RHFC method uses hydrogen as the fuel similar to a Polymer Electrode Membrane (PEM) method, it is advantageous in terms of output, power capacity per unit volume, and that no reactants are required besides water. However, as it requires a reformer in a fuel cell system, it is disadvantageous for miniaturization.

As described above, in order for the fuel cell to have high output density, a reformer is required to convert liquid fuel into fuel gas such as hydrogen gas. Such a reformer includes an evaporating part for gasifying methanol solution, a reforming part for converting methanol into hydrogen through a catalytic reaction at a temperature ranging from 200° C. to 320° C., and a CO removing part (or PROX part) for removing CO which is a by-product of reforming. In the reforming part, heat absorption reaction takes place and the temperature should be maintained between 200° C. and 320° C. The CO removing part, where heat is generated, should also be maintained at about 150° C. to 220° C. to yield high reaction efficiency.

The current fuel cells are too voluminous for use as mobile power sources. Direct methanol fuel cells are under development for miniaturization, but with its low efficiency, PEMFCs should ultimately be developed for miniaturization. The major difference between the DMFC and the PEMFC is the reformer. In order to manufacture a micro fuel cell, a micro reformer is needed.

The essence of such a reformer (fuel reformation) technology involves production and supply system of hydrogen necessary for driving a stacked structure of fuel cell. The factors necessary for increasing the efficiency of the reformer include miniaturization, light-weight, quick startup and dynamic response characteristics, and reduced manufacturing costs.

The reforming apparatuses developed to date are made of metallic material such as wafers or aluminum, and adopt gaskets. Using the metallic material, the reformers can be operated at a normal temperature without any problems but can be restricted in their operations at a high temperature due to the properties of the metallic material.

In addition, since they do not have an integrated structure, there may be possibility of fuel or gas leakage, and thus require gaskets which is durable and can withstand high temperature (200˜320° C.).

Using the gaskets, the volume of the reformer is increased from that of the integrated structure. Moreover, made of metallic material, it is heavy in weight. As the major issue for the fuel cell systems for mobile devices is miniaturization, there should be researches conducted on ways to reduce the volume and weight.

FIG. 1 illustrates a conventional reformer 250 disclosed in Japanese Patent Application Publication No. 2003-045459. This conventional reformer includes a first substrate 252, which is a plate-shaped cover, and a second substrate 254 with a flow path groove 254a formed in one side thereof with a catalyst 254b formed on the wall of the flow path groove 254a. The reformer also includes a third substrate 256 having an insulation cavity 256b formed in a mirror surface 256a thereof, a reformer having a catalyst 254b formed in the groove 254a of the second substrate 254 for generating hydrogen gas and CO₂ from methanol and water, and a thin-film heater 258 disposed underneath the catalyst 254b.

Such a conventional reformer has the heater 258 disposed in the flow path to increase heat efficiency but its structure is complicated to manufacture and the catalyst 254b does not utilize entire space of the reformer, resulting in low reforming efficiency.

FIG. 2 illustrates another conventional reformer suggested in Japanese Patent Application Publication No. 2004-066008. In such a conventional reformer, a highly efficient heat conducting part 313 made of highly conductive aluminum, etc. is disposed between substrates 311 and 312, and a reactive catalyst 316 is provided in a flow path formed in an inner surface of the main substrate 311.

A combustion catalyst 317 is provided in a flow path 315 formed in an inner surface of the combustion substrate 312, and a thin film heater 323 is provided on an outer surface of the combustion substrate 312.

However, in the above conventional structures, the substrates are machined to form the flow paths thereon, thus requiring difficult manufacturing processes, thereby hindering miniaturization and light weight of the reformer.

### SUMMARY OF THE INVENTION

The present invention has been made to solve the foregoing problems of the prior art and therefore an object of certain embodiments of the present invention is to provide a multi-layer ceramic substrate reforming apparatus for a micro fuel cell system which has a complete sealing effect to ensure stable operation without a gasket or screw, thereby achieving a small, thin and light-weight structure.

According to an aspect of the invention for realizing the object, there is provided a thin multi-layer ceramic substrate reforming apparatus for a micro fuel cell system, including: an upper cover made of ceramic material, the upper cover having a fuel inlet at one side thereof; an evaporator made of a plurality of ceramic layers formed integrally at one side of the upper cover, the evaporator having a flow path to gasify fuel introduced through the upper cover; a reformer made of a plurality of ceramic layers formed at one side of the evaporator, the reformer having a catalyst in a flow path thereof to reform fuel gas entering from the evaporator into hydrogen; a CO remover made of a plurality of ceramic layers formed integrally at one side of the reformer, the CO remover having a catalyst to remove CO from reformed gas entering from the reformer; and a lower cover formed integrally at one side of the CO remover, the lower cover having a reformed gas outlet to emit the reformed gas to the outside.

According to another aspect of the invention for realizing the object, there is provided a manufacturing method of a thin reforming apparatus for a micro fuel system, including steps of:

forming an upper cover, an evaporator, a reformer, a CO remover and a lower cover using plates of ceramic material;

disposing a heating wire on each of bottom surfaces of the evaporator, the reformer and the CO remover;

stacking the upper cover, the evaporator, the reformer, the CO remover and the lower cover to fire and integrate the same; and

filling a catalyst in each of the reformer and the CO remover, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a conventional reforming apparatus for a micro fuel cell system;

FIG. 2 is a sectional view illustrating another conventional reforming apparatus for a micro fuel cell system;

FIG. 3 is an exploded perspective view illustrating a multi-layer ceramic substrate reforming apparatus for a micro fuel cell system according to the present invention;

FIG. 4 is a structural view illustrating an evaporator of the multi-layer ceramic reforming apparatus for a micro fuel cell system in which (a) is an exploded perspective view and (b) is a sectional view;

FIG. 5 is a structural view illustrating a reformer of the multi-layer ceramic substrate reforming apparatus for a micro fuel cell system in which (a) is an exploded perspective view and (b) is a sectional view;

FIG. 6 is a structural view illustrating a CO remover of the multi-layer ceramic substrate reforming apparatus for a micro fuel cell system in which (a) is an exploded perspective view and (b) is a sectional view;

FIG. 7 is an exploded perspective view illustrating a stacked structure of the multi-layer ceramic substrate reforming apparatus for a micro fuel cell system; and

FIG. 8 is a graph illustrating a firing process for manufacturing the multi-layer ceramic substrate reforming apparatus according to the present invention.

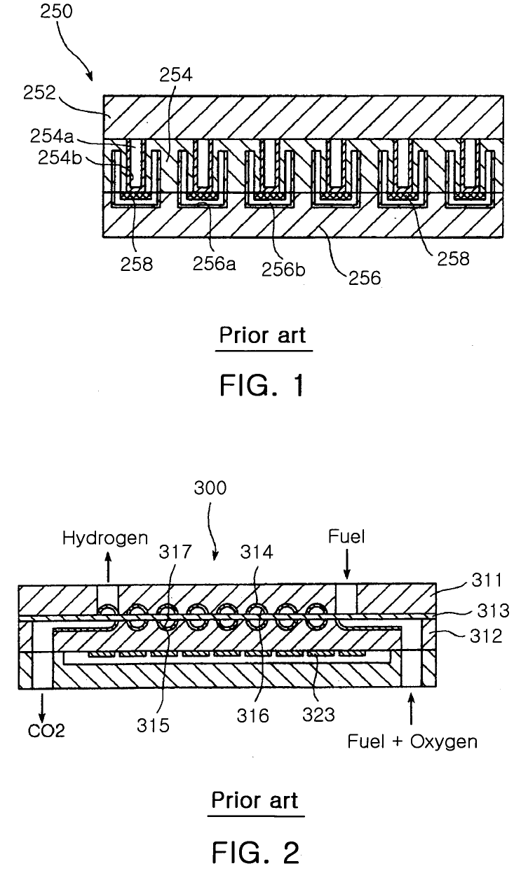

### DETAILED DESCRIPTION OF THE PREFERRED EMBODIMENT

Preferred embodiments of the present invention will now be described in detail with reference to the accompanying drawings.

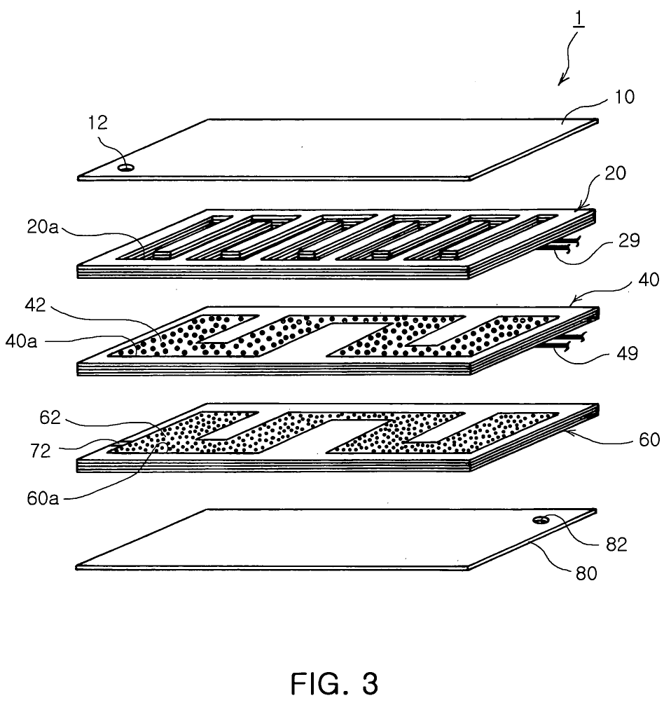

As shown in FIG. 3, a multi-layer ceramic substrate reforming apparatus 1 for a fuel cell system according to the present invention includes an upper cover 10 having a fuel inlet 12 formed at one side thereof. The upper cover 10 is made of Low-Temperature Co-fired Ceramic (LTCC).

The LTCC used in this invention is a green sheet made of ceramic material having a thickness of about 0.1 to 1 mm. After the LTCC is fired, the polymer binder is completely oxidized and not found, and only the ceramic material is left, thus having an advantage of not being deformed by heat. In an LTCC process, a ceramic tape is used to form a pattern on the green sheets which are then made into a single structure via a firing process.

In addition, the reforming apparatus 1 of the present invention includes an evaporator 20 formed at one side of the upper cover 10. The evaporator 20 is made of a plurality of ceramic layers and has a flow path 20a to gasify fuel introduced through the upper cover 10.

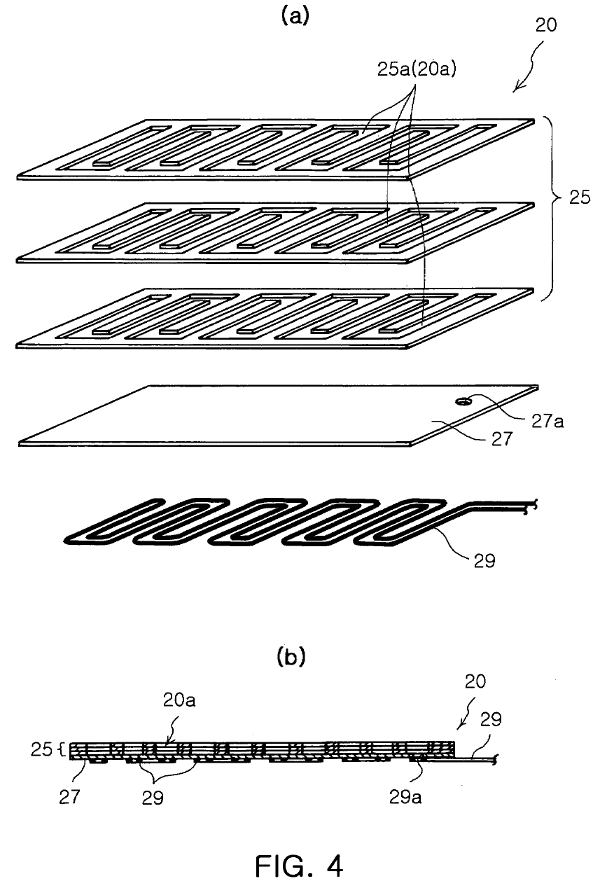

As illustrated in detail in FIG. 4, the evaporator 20 has the plurality of ceramic layers made of LTCC which are stacked and fired to form a single structure.

That is, the evaporator 20 includes a plurality of flow path layers 25 each having an open area formed in a same zigzag shape, stacked on one another to form a flow-path perforation 25a. The evaporator 20 also includes a backing layer 27 formed integrally at a lower part of the flow path layers 25 to block a bottom of the flow-path perforation 25a, thereby forming the flow path 20a. The backing layer 27 serves to separate between the evaporator 20 and the reformer 40, explained later.

On the bottom surface of the backing layer 20, material such as white gold (Pt) or tantal-aluminum (Ta—Al) is patterned to form a heating wire for heating the evaporator 20, as explained later.

In addition, the backing layer 27 has a fuel gas passage 27a formed at one side thereof for transferring fuel gas gasified from liquid in the flow path to the reformer 40 explained later.

In addition, the reforming apparatus 1 of the invention includes a reformer 40 formed at a side of the evaporator 20 and made of a plurality of ceramic layers. The reformer 40 has a catalyst formed on the inner wall of a flow path thereof to reform the fuel gas flowing from the evaporator 20 into hydrogen.

The reformer 40 is integrally continued from the evaporator 20. Its flow path 40a is formed in a zigzag shape and has a catalyst 42 formed therein for reforming the fuel into hydrogen gas.

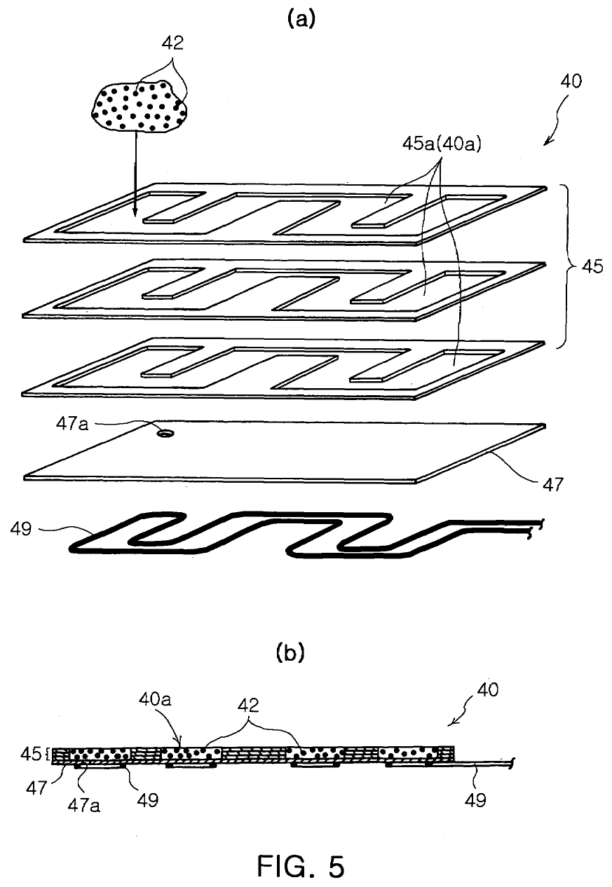

The reformer 40, as shown in detail in FIG. 5, has a plurality of ceramic layers made of LTCC, which are stacked and fired to form a single structure.

That is, the reformer 40 includes a plurality of flow path layers 45 each having an open area perforated in a same zigzag shape to form a flow-path perforation 45a. The reformer 40 also includes a backing layer 47 formed integrally at a lower part of the flow path layers 45 to block a bottom of the flow-path perforation 45a of the flow path layers 45, thereby forming the flow path 40a. The backing layer 46 serves to separate the reformer 40 from the CO remover 60, explained later.

In the reformer 40, fuel gas is reformed into hydrogen-rich reformed gas via catalytic reaction. The catalyst 42 of the reformer 42 is made of Cu/ZnO or Cu/ZnO/Al₂O₃. The catalyst 42 may be made up of catalyst particles filled in the flow path 40a. In this case, the catalyst 42 has a preferable configuration that the particles thereof do not enter the evaporator 20 at a front side of the reformer 40, or the CO remover 60 at a back side of the reformer 40.

In addition, in the reformer 40, a material such as white gold (Pt) or tantal-aluminum (Ta—Al) is patterned on a lower surface of the backing layer 47 to form a heating wire 49 for heating the reformer 40, as described later.

The heating wire 49 of the reformer 40 is also effective for heating the CO remover 60, explained later.

That is, the location of the heating wire 49 formed on the backing layer 48 corresponds to an upper part of the CO remover 60, thus effective for heating the CO remover as well.

In addition, the backing layer 47 of the reformer 40 has a reformed gas passage 47a formed at a side thereof for transferring reformed gas, obtained from the fuel gas through reaction with the catalyst 42 formed on the inner wall of the flow path 40a, to the CO remover 60, explained later.

Moreover, the reformer 1 of the invention includes the CO remover 60 formed integrally at a side of the reformer 40. The CO remover 60 is made of a plurality of ceramic layers and has a catalyst 62 to remove CO from the reformed gas flowing from the reformer 40.

The CO remover 60 is integrally continued from the reformer 40 and has a flow path 60a formed in a zigzag shape therein. The flow path 60a has a catalyst 62 formed therein for converting harmful CO, contained in the reformed gas entering from the reformer 40, into harmless CO₂.

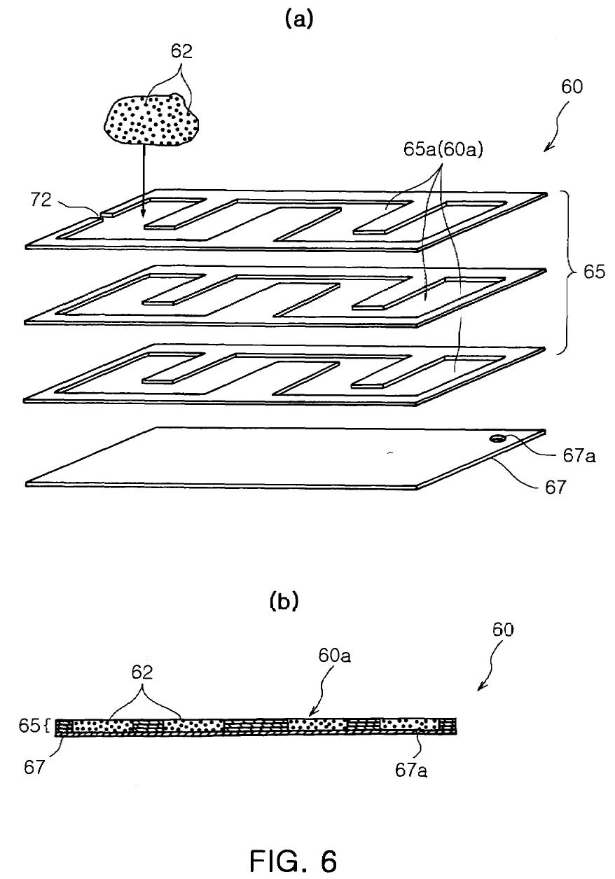

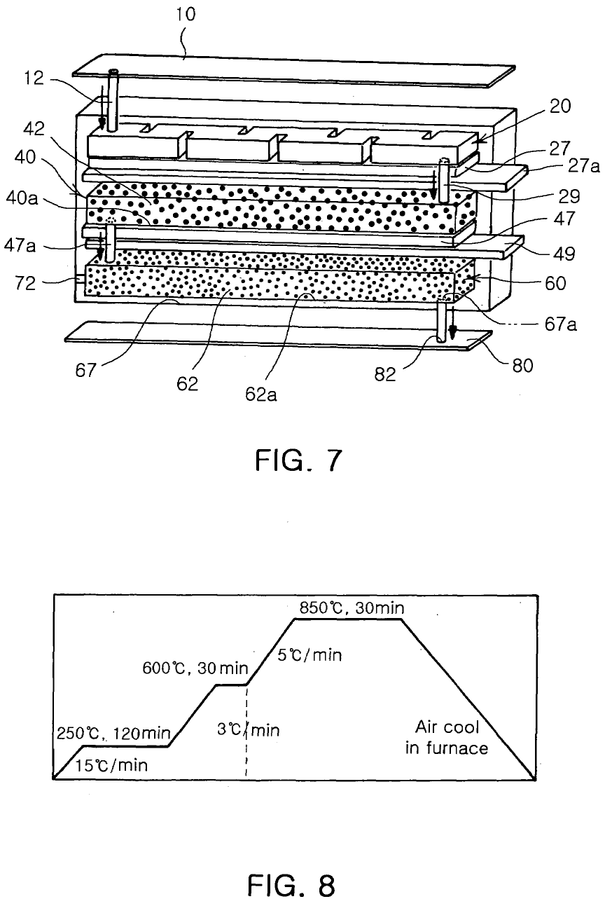

As shown in detail in FIG. 6, the CO remover 60 is made of a plurality of ceramic layers made of LTCC, which are stacked and fired to form a single structure.

That is, the CO remover 60 includes a plurality of flow path layers 65 each having an open area perforated in a same zigzag shape. The flow path layers 65 are stacked on one another to form a flow-path perforation 65a. The CO remover also includes a backing layer 67 formed integrally at a lower part of the flow path layers 65 to block a bottom of the flow-path perforation 65a, thereby forming the flow path 60a. The backing layer 67 serves to separate the CO remover 60 from the lower cover 80, explained later.

The flow path layer 65 has an air inlet 72 formed at a side thereof. The air inlet 72 is for supplying oxygen from the outside, which is necessary for the catalyst 62 formed in the CO remover 60 to convert CO into CO₂.

As described above, the CO remover 60 converts CO contained in the reformed gas into CO₂. In order for this process, the catalyst 62 used in the CO remover 60 may be in the form of particles made of one selected from a group consisting of Pt, Pt/Ru and Cu/CeO/Al₂O₃.

In this case, the catalyst 62 has a preferable configuration that the particles thereof do not enter the reformer 40 at a front side of the CO remover 60 or escape out of the CO remover 60 through a back side thereof.

In addition, the backing layer 67 of the CO remover 60 has a reformed gas outlet 67a formed at a side thereof for emitting hydrogen-containing reformed gas after CO is converted to CO₂ in the flow path 60a.

In addition, the reforming apparatus 1 of this invention includes a lower cover 80 formed integrally at a side of the CO remover. The lower cover 80 has a reformed gas outlet 82 to emit the reformed gas to the outside.

The lower cover 80 is made of LTCC, and has a reformed gas outlet 82 for emitting the reformed gas to the outside.

In the multi-layer ceramic substrate reforming apparatus 1 for a micro fuel cell system with the above configuration, liquid fuel is introduced through the fuel inlet 12 of the upper cover 10 into the flow path of the evaporator 20. Such liquid fuel is heated and gasified in the evaporator 20 at a temperature between 200° C. to 320° C. required for reforming, by the heating wire 29 formed on a bottom surface of the backing layer 27.

Next, the gasified fuel is transferred to the reformer 40 through the fuel gas passage 27a formed downstream of the evaporator 20. In the reformer 40, catalytic reaction accompanying heat absorption reaction takes place, during which the fuel gas is converted via catalytic reaction to reformed gas containing CO and CO₂ while being continually heated at a temperature between 200° C. to 320° C. by the heating wire 49 formed on a bottom surface of the backing layer 47 of the reformer 40.

The reformed gas is transferred to the CO remover 60 through the reformed gas passage 47a formed downstream of the reformer 40.

The reformed gas passes through the CO remover 60 with air being supplied through the air inlet 72.

In the CO remover 60, catalytic reaction of selective oxidization accompanying heat generation reaction takes place at a temperature of about 150° C. to 220° C., and CO in the reformed gas is converted to CO₂ harmless to humans.

Therefore, while passing through the CO remover 60, the reformed gas is converted to contain hydrogen gas and CO₂ harmless to humans, which is then emitted to the outside through the reformed gas outlet 67a formed in the backing layer 67 of the CO remover 60 and through the reformed gas outlet 82 of the lower cover 80.

In the above process, the heating wire 49 installed at the bottom surface of the reformer 40 provides the heat between 200° C. to 320° C. necessary for the reformer 40 and the CO remover 60.

In the meantime, the air necessary for oxidization reaction in the CO remover 60 should be supplied from the outside. According to the present invention, the air is supplied into the CO remover 60 from an external pump (not shown) through the air inlet 72 formed at the flow path layer 65 of the CO remover 60, effectively converting CO to CO₂.

Now, a method for manufacturing the multi-layer ceramic substrate reforming apparatus 1 for a micro fuel cell system is as follows.

The manufacturing method for the multi-layer ceramic substrate reforming apparatus for a micro fuel cell system starts with a step of machining LTCC sheets to form an upper cover 10, an evaporator 20, a reformer 40, a CO remover 60 and a lower cover 80.

In the above step, a ceramic green sheet making up the LTCC having a thickness of about 0.1 to 1 mm is physically machined. Such ceramic green sheets making up the LTCC are machined into desired shapes of the upper cover 10, the evaporator 20, the reformer 40, the CO remover 60 and the lower cover 80 by a PCB machining apparatus.

That is, a fuel inlet 12 is formed in the upper cover 10. A flow-path perforation 25a is formed in each of a plurality of LTCC ceramic green sheets to form a flow path 25 of the evaporator 20. A fuel gas passage 27a is formed in a backing layer 27 of the evaporator 20. Then, the green sheets are stacked on the backing layer 27 to form the evaporator 20.

For the reformer 40, a flow-path perforation 45a is formed in each of a plurality of LTCC ceramic green sheets to form a flow path 45 of the reformer 40. A reformed gas passage 47a is formed in a backing layer 47 of the reformer 40. Then, the green sheets having the flow path layers 45 are stacked on the backing layer 47 to form the reformer 40.

For the CO remover 60, a flow-path perforation 65a is formed in each of a plurality of LTCC ceramic green sheets to form a flow path 65 of the CO remover 60. An air inlet 72 is formed at a side of the green sheets, and a reformed gas outlet 67a is formed in a backing layer 67 of the CO remover 60.

Then, the green sheets are stacked on the backing layer 67 to form the CO remover 60.

In addition, a reformed gas outlet 82 of the lower cover 80 is formed corresponding to the reformed gas outlet 67a of the CO remover 60.

Then the next step of the manufacturing method for the multi-layer ceramic substrate reforming apparatus 1 for a micro fuel cell system entails disposing heating wires 29 and 49 on bottom surface of the evaporator 20 and the reformer 40, respectively.

In the step, material such as Pt or Ta—Al is patterned to form the heating wires 29 and 49 on bottom surfaces of the backing layers 27 and 47 of the evaporator 20 and the reformer 40, respectively.

After the heating wires 29 and 49 are disposed as described above, the upper cover 10, the evaporator 20, the reformer 40, the CO remover 60 and the lower cover 80 are stacked to be fired and integrated.

In such an integrating step, the upper cover 10, the evaporator 20, the reformer 40, the CO remover 60 and the lower cover 80 are stacked inside a furnace (not shown), and are integrated through a series of firing phases shown in FIG. 8 into a single structure.

That is, in the integrating step, the temperature in the furnace is raised by 1.5° C. per minute up to 250° C. Then, the raise temperature of 250° C. is maintained for 120 minutes. Then, the temperature is further raised by 3° C. per minute up to 600° C. The raise temperature of 600° C. is maintained for 30 minutes.

Then, the temperature is further raised by 5° C. per minute up to 850° C. The raise temperature of 850° C. is maintained for 30 minutes. Lastly, the stacked structure is naturally air cooled.

When the LTCC constructing the ceramic stacked structure is fired as described above, polymer binder is completely oxidized and only the ceramic material is left. Thus, the LTCC is not deformed by heat and forms a solid structure.

In addition, in the LTCC technique, the heating wire patterns are formed on the ceramic green sheets, which are then stacked and fired to form a single structure, facilitating the manufacturing processes.

The ceramic green sheets constructing the LTCC are machined using a PCB machining apparatus to form desired shapes of the flow paths 20a, 40a and 60a therein. The LTCC has very soft physical properties before firing, thus easily machined in a shorter time than metallic material. And after being machined, it is fired by raising the temperature stepwise as described above using a box furnace.

Once the firing is completed, more firmly solidified LTCC structure of the reforming apparatus is obtained.

In addition, the manufacturing method includes filling in catalysts in the reformer 40 and the CO remover 60, respectively.

In this step, the catalysts 42 and 62 are filled in the flow paths 40a and 60a of the reformer 40 and the CO remover 60 completed in the firing step. In this case, catalyst inlets (not shown) are formed in locations of the side of the multi-layer ceramic substrate reforming apparatus 1 connected to the flow paths 40a and 60a of the reformer 40 and the CO remover 60. Then, the particle-type catalysts 42 and 62 are injected through the catalyst inlets which are sealed with ceramic material later.

In this case, the catalyst 42 of the reformer 40 is made of Cu/ZnO or Cu/ZnO/Al₂O₃, and the particles of the catalyst 42 are preferably sized such that they do not enter the evaporator 20 at the front side of the reformer 20 or the CO remover 60 at the back side of the reformer 40.

The catalyst 62 for the CO remover 60 is preferably is made up of particles made of one selected from a group consisting of Pt, Pt/Ru and Cu/CeO/Al₂O₃. The particles of the catalyst 62 do not enter the reformer 40 at the front side of the CO remover 60 or escape from the CO remover 60 through the back side thereof.

Therefore, according to the present invention, the LTCC is used to form an integrated reforming apparatus, thereby realizing an ultra-light ceramic structure without needing a gasket or a screw.

The reforming apparatus obtained according to the present invention is smaller in volume and weight than conventional metallic reforming apparatuses or conventional reforming apparatuses using bolt-bound LTCC and gaskets.

In addition, the reforming apparatus of the invention is a structure formed by being fired at one time so that it is more preventive of gas leakage than the conventional gasket types. Further, due to the characteristics of the LTCC, it can be driven at a normal temperature as well as at a high temperature, thus not restricted by operating temperatures.

Therefore, the reforming apparatus of the invention achieves a thin and light-weight structure suitable for use in a micro fuel cell system.

While the present invention has been shown and described in connection with the preferred embodiments, it will be apparent to those skilled in the art that modifications and variations can be made without departing from the spirit and scope of the invention as defined by the appended claims.

What is claimed is:

1. A thin multi-layer ceramic substrate reforming apparatus for a micro fuel cell system, comprising:
an upper cover made of ceramic material, the upper cover having a fuel inlet at one side thereof;
an evaporator made of a plurality of ceramic layers formed integrally at one side of the upper cover, the evaporator having a flow path to gasify fuel introduced through the upper cover;
a reformer made of a plurality of ceramic layers formed at one side of the evaporator, the reformer having a catalyst in a flow path thereof to reform fuel gas entering from the evaporator into hydrogen;
a CO remover made of a plurality of ceramic layers formed integrally at one side of the reformer, the CO remover having a catalyst to remove CO from reformed gas entering from the reformer; and
a lower cover formed integrally at one side of the CO remover, the lower cover having a reformed gas outlet to emit the reformed gas to the outside.

2. The thin multi-layer ceramic substrate reforming apparatus according to claim 1, wherein the evaporator comprises:
a plurality of flow path layers each having an open area formed in a same zigzag shape, the plurality of flow path layers stacked on one another to form a flow-path perforation;
a backing layer formed integrally at a lower part of the flow path layers, the backing layer blocking the bottom of the flow path layers to form the flow paths and distinguish between the evaporator and the reformer;
a heating wire disposed on a bottom surface of the backing layer to heat the evaporator.

3. The thin multi-layer ceramic substrate reforming apparatus according to claim 2, wherein the backing layer has a fuel gas passage for transferring the gasified fuel to a reformer, the fuel gasified from liquid in the flow path of the evaporator.

4. The thin multi-layer ceramic substrate reforming apparatus according to claim 1, wherein the reformer comprises:
a plurality of flow path layers each having an open area formed in a same zigzag shape, the plurality of flow path layers stacked on one another to form a flow-path perforation;
a backing layer formed integrally at a lower part of the flow path layers, the backing layer blocking the bottom of the flow path layers to form the flow path and distinguish between the reformer and the CO remover;
a catalyst filled in the flow path;
a heating wire disposed on a bottom surface of the backing layer to heat the reformer.

5. The thin multi-layer ceramic substrate reforming apparatus according to claim 4, wherein the catalyst of the reformer is made of Cu/ZnO or Cu/ZnO/Al₂O₃.

6. The thin multi-layer ceramic substrate reforming apparatus according to claim 4, wherein the backing layer has a reformed gas passage for transferring the gasified fuel to the CO remover, the gasified fuel obtained through reaction with the catalyst in the flow path of the reformer.

7. The thin multi-layer ceramic substrate reforming apparatus according to claim 1, wherein the CO remover comprises:
a plurality of flow path layers each having an open area formed in a same zigzag shape, the plurality of flow path layers stacked on one another to form a flow-path perforation;
a backing layer formed integrally at a lower part of the flow path layers, the backing layer blocking the bottom of the flow path layers to form the flow path and distinguish between the CO remover and the lower cover;
a catalyst filled in the flow path for converting CO into CO₂.

8. The multi-layered ceramic reforming apparatus according to claim 7, wherein the catalyst of the CO remover comprises particles made of one selected from a group consisting of Pt, Pt/Ru and Cu/CeO/Al₂O₃.

9. The multi-layer ceramic substrate reforming apparatus according to claim 7, wherein the flow path of the CO remover has an air inlet at one side thereof for providing oxygen needed for converting CO to CO₂, and a reformed gas outlet at the other side thereof for emitting reformed gas generated therethrough.

10. The multi-layer ceramic substrate reforming apparatus according to claim 1, wherein the ceramic material comprises Low-Temperature Co-fired Ceramic (LTCC).

11. A manufacturing method of a thin reforming apparatus for a micro fuel system, comprising steps of:
forming an upper cover, an evaporator, a reformer, a CO remover and a lower cover using plates of ceramic material;
disposing a heating wire on each of bottom surfaces of the evaporator, the reformer and the CO remover;
stacking the upper cover, the evaporator, the reformer, the CO remover and the lower cover to fire and integrate the same; and
filling a catalyst in each of the reformer and the CO remover, respectively.

12. The method according to claim 11, wherein the ceramic material comprises Low-Temperature Co-fired Ceramic (LTCC).

13. The method according to claim 11, wherein the integrating step comprises:
raising a temperature in a furnace by 1.5° C. per minute up to 250° C.;
maintaining the raised temperature of 250° C. for 120 minutes;
raising the temperature by 3° C. per minute up to 600° C.;
maintaining the raised temperature of 600° C. for 30 minutes;
raising the temperature by 5° C. per minute up to 850° C.;
maintaining the raise temperature of 850° C. for 30 minutes; and
naturally air cooling the stacked structure.
